(19) United States
(12) Patent Application Publication
(10) Pub. No.: US 2006/0026871 A1
(43) Pub. Date: Feb. 9, 2006

(54) Combination embark-debark luggage tag

(76) Inventors: George Alexander JR., Dickinson, TX (US); Maria Jennings Alexander, Dickinson, TX (US)

Correspondence Address: George Alexander, Jr., 2719 Frostwood Circle, Dickinson, TX, 77539, US

(21) Appl. No.: 10/910,518

(22) Filed: Aug. 3, 2004

(51) Int. Cl. G09F 3/20

(52) U.S. Cl. 40/6

(57) ABSTRACT

The new “Combination Embark-Debark Luggage Tag” is technically superior and operationally much more cost effective than the “old separate Embarkation” and “old separate Debarkation” luggage tags currently being used by the Cruise Line Industry because: (1) the new “Combination Embark-Debark Luggage Tag” unique design, provides 26 critical parameters of Passenger Reservation Information, (2) which are readily available and easy retrievable from the cruise line's reservation data base, (3) are easily printed directly onto the new invention “pre-printed basic luggage tag” design, (4) remains on the passenger's luggage throughout both the embark and debark process, (5) are necessary for everyone involved with the current inefficient luggage handling process.

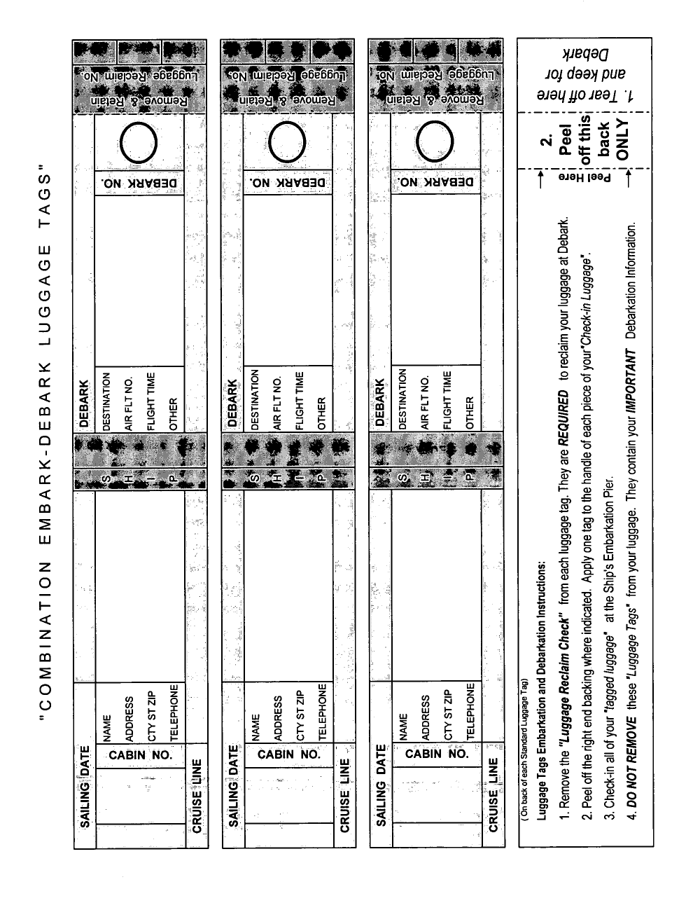

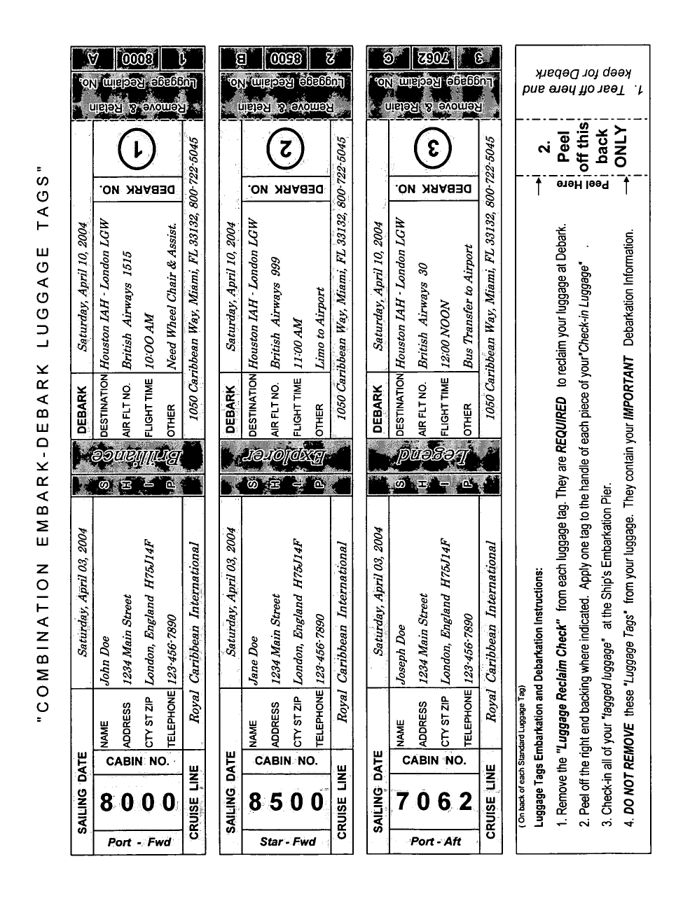

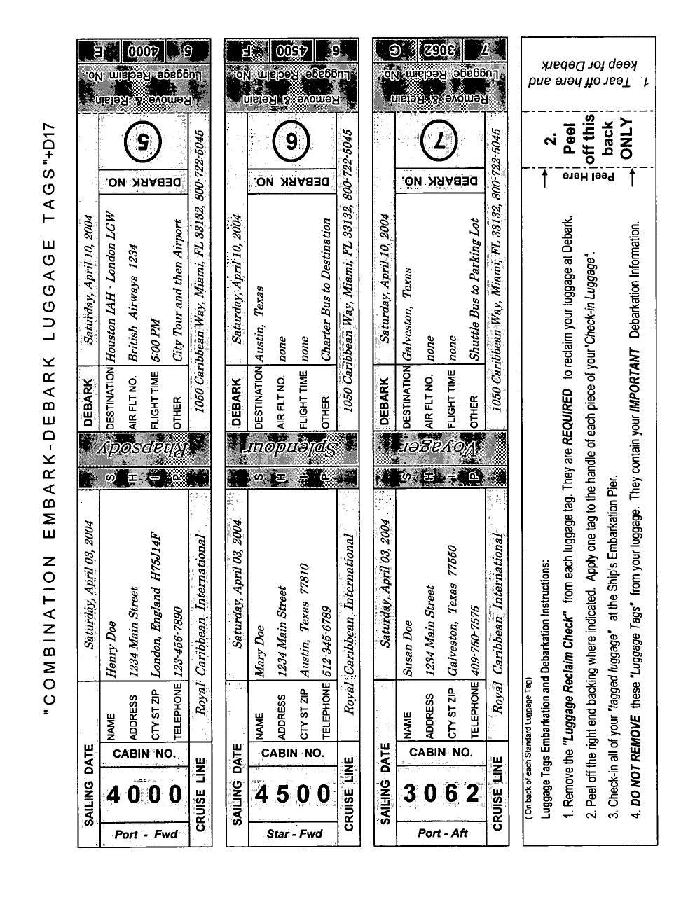

### CROSS REFERENCES TO RELATED APPLICATIONS

Based on USPTO Internet Site “Patent Search”, regarding related applications, to the best of our knowledge, there have not been any prior filed copending nonprovisional applications submitted, or patents granted on this subject matter.

### STATEMENT OF FEDERALLY SPONSORED RESEARCH OR DEVELOPMENT

Federally Sponsored Research or Development has not been in the past, and will not be in the future, either requested, received, or denied in support of this new invention entitled “Combination Embark-Debark Luggage Tag” which was independently developed by Maria Jennings Alexander and George Alexander, Jr.

### COMPUTER PROGRAM LISTING

The design of the invention entitled “Combination Embark-Debark Luggage Tag” was accomplished using Microsoft's Windows XP Operating System and Excel Software, a copy of which shall be provided to the USPTO upon request.

### BACKGROUND OF INVENTION

Critical functions of the Cruise Line Industry include getting passengers and their luggage:
(1) from the Port Terminals to the Ship's Cabins, known as “Embarkation”, and
(2) from the Ship's Cabins to the Port Terminals, known as “Debarkation”.

These tasks can only be accomplished by providing everyone involved with adequate passenger reservation information to get the job done, carefully, accurately, and cost effectively.

The 2,000-4,000 pieces of passenger's embarked luggage must be distributed throughout:
(1) the ship's 1 to 12 decks,
(2) 500 to 1,000 passenger cabins, while
(3) 1,000 to 2,000 passengers are congesting the 3 to 4 foot wide corridors.

This task is currently being done without adequate passenger embarkation reservation information, and therefore causes delays in luggage deliveries, deliveries to the wrong Staterooms, and damaged and lost passenger's luggage problems.

The luggage “Debarkation” task is relatively simple compared to the “Embarkation” task:
(1) debark luggage pickup begins after midnight, when passengers are in bed,
(2) debark luggage is off loaded to the Terminal, without any pre-sorting, and
(3) Terminals have large open areas for passengers to reclaim their debarked luggage.

Even with these critical functions, the Cruise Line Industry continues to use obsolete luggage tags, with insufficient passenger reservation information, for the massive and time consuming tasks of loading and unloading the voluminous quantity of passenger luggage onto and off of their ships.

Embark and Debark passenger luggage problems may be describe by current average cruise line industry numbers: 2 luggage cycles/day, 1 day/week, 50 weeks/year, on 100 ships.

Doing the math: 2×1×50×100=10,000 cruise industry total “on-off luggage cycles”/year.

The average ship carries 1,500 passengers, and the average passenger checks-in 2 pieces of luggage. Doing more math: 10,000×1,500×2=30,000,000 total pieces of luggage every year, must be cycled on and off carefully, accurately, and cost effectively by the Cruise Line Industry.

History has proven that the many different types of separate “Embark Luggage Tags” and the many different types of separate “Debark Luggage Tags” currently being used by the Cruise Line Industry do not contain the passenger reservation information which is required in order to accomplish the much needed cost effective solution to the industry wide luggage handling problems.

The objective of the new “Combination Embark-Debark Luggage Tag” invention is to provide the cruise line industry with a “standard luggage tag” to be used by all Cruise Lines, on all Ships, at all Terminals, by all Security Screeners, and by all Luggage Handlers, and provides the complete and accurate passenger reservation information, which will result in a cost effective solution to luggage handling problems currently being experienced by the Cruise Line Industry.

### BRIEF SUMMARY OF INVENTION

The new “Combination Embark-Debark Luggage Tag” invention incorporates the following major improvements over currently used separate “Embark Luggage Tags” and separate “Debark Luggage Tags”:
(1) only ONE new “Combination Embark-Debark Luggage Tag” is required for BOTH the Embarkation and Debarkation passenger's luggage processing, and
(2) the new “Combination Embark-Debark Luggage Tag” design provides the following 26 pieces of information, which are easily retrieved from each Cruise Line's “Passenger's Reservation Information” data base:
   A. For the Embarkation Process, each Passenger's:
      1. Cruise Line's Name, Ship's Name, and Ship Sailing Date,
      2. Cabin Number and Quadrant Location within the Ship, and
      3. Name, Address, City, State, Zip, and Telephone No.
   B. For the Debarkation Process, each Passenger's:
      1. Debarkation Date and Debark No.,
      2. Luggage Reclaim Checks and Numbers,
      3. Intermediate and Final City Destinations,
      4. Airline, Flight Nos. and Flight Times,
      5. Special Requirements Needs,
      6. Bus Transfers to Airports and Cruise Sponsored Tour Buses,
      7. Special Charter Buses and Shuttle Buses to Parking Lots, and
      8. Taxis, Limos, and Pickups by Personal Autos.

The size of each new luggage tag may vary from 11 to 14 inches in length and 2⅛ to 2¾ inches in width. These sizes allow 3 or 4 new luggage tags to be made from standard size sheets of 11×8½ inches or 14×8½ inches, thereby reducing the cost of basic pre-printing forms production, and for compatibility with current standard size computer printers for printing the Passenger's Reservation Information onto the basic luggage tag forms.

The new “Combination Embark-Debark Luggage Tag” is functionally divided and color coded into two halves. As shown in the enclosed drawings, the left half of the new luggage tags (Blue Color Code) is used for Passenger's Embarkation Information, and the right half of the new luggage tags (Yellow Color Code) is used for Passenger's Debarkation Information.

Note: Blue and Yellow colors were used for illustration purposes only; any color combinations may be used to accommodate each Cruise Line's preference.

### DETAILED DESCRIPTION OF INVENTION

Sets of 3 to 4 new “Combination Embark-Debark Luggage Tags” are pre-printed with only:
(1) “Fixed Parameters” pre-printed on the front side of each tag,
(2) “Luggage Embark and Debark Instructions” pre-printed on back of each tag, and
(3) Each of the 3 to 4 tags may be 11 to 14 inches long and 2⅛ to 2¾ inches wide.

Bulk pre-printing uses standard size sheets of either 11×8½ inch, or 14×8½ inch, medium weight, white, peel and stick label stock. Each sheet is perforated vertically across the right 8½ inch end for the passenger's easy removal of the “Luggage Reclaim Checks”. Horizontal perforations separate each of the 3 or 4 luggage tags. Only the backing of the “Debark No.” is perforated in order to stick the two tag ends together when applying the tags to the luggage handles.

Twenty-six parameters available from each Cruise Line's Passenger Reservation System is retrieved and printed onto the pre-printed sets of 3 to 4 “Combination Embark-Debark Luggage Tags”. One sheet of the 3 to 4 printed passenger luggage tags and a separate sheet of instructions are forwarded to each passenger.

“Luggage Tag Instructions” which are forwarded to each passenger shall include:
(1) please review the information on the enclosed Luggage Tags for accuracy, and advise us immediately of any errors,
(2) remove the “Luggage Reclaim Checks” from each Luggage Tag, and store them with your Cruise Documents for reference at the end of your cruise.
(3) “Luggage Reclaim Checks” are required to claim your luggage at the Debark Pier,
(4) remove the backing only from the back side of the “Debark No.”, and apply one “Combination Embark-Debark Luggage Tag” to the handle, of each piece of luggage to be Checked-in at the Embarkation Pier,
(5) personally check-in your “tagged luggage” at the Ship's Embarkation Pier, and
(6) most importantly, upon receipt of your tagged checked-in luggage in your Cabin, DO NOT REMOVE the “Combination Embark-Debark Luggage Tags” from your luggage. These luggage tags also contain very important Debarkation Information.

During the “Passenger Reservation Process”, the Cruise Line shall assign each passenger a “Debark Number”. The “Circled Debark No.” printed on each passenger's “Combination Embark-Debark Luggage Tag” is based upon each passenger's specific debarkation requirements.

For Example:
(a) “Circled Debark No. “1”, includes only those passengers who require “Special Assistance” during debarkation,
(b) “Circled Debark No. “2”, includes only those passengers who have Airline Flights departing before noon.

Debark Numbers are assigned to passengers according to the following reservation needs:
Debark No. Needs of Passengers
1 restricted to passengers requiring Special Assistance
2 with Airline Flights departing before 12 noon
3 with Airline Flights departing before 1 pm
4 with Airline Flights departing before 2 pm
5 with Airline Flights departing from Regional Airports
6 with Cruise Sponsored Tours
7 with Charter Bus Transportation
8 with Personal Transportation
9 for Other Uses

“Circled Debark Nos.” on the “Combination Embark-Debark Luggage Tag” are the same as the “first digit” of the number on the passenger's “Luggage Reclaim Check”.

For example:
if the passenger's Luggage Reclaim Check No. is “1-8000-A”, then:
their Debark No. is “1”, their Cabin No. is “8000”, and
their 4 pieces of Luggage are the letters “A”, “B”, “C”, or “D”.

On the last day of the cruise, the passengers debark luggage shall be transferred from the Ship to the inside of the Terminal Building at the Port.

All debark passenger luggage inside the Terminal Building shall be sorted according to the “Circled Debark Number” on the passenger's “Combination Embark-Debark Luggage Tag”.

Passengers should debark the ship ONLY when their “Circled Debark Number” is announced, and ONLY after they have cleared Immigration. Passengers must submit their “Luggage Reclaim Checks” when claiming their luggage at the Pier.

If passenger luggage becomes “Lost, Damaged or Unclaimed”, a Shore Services Representative will prepare a report based on the information available on the “Combination Embark-Debark Luggage Tag”.

The new “Combination Embark-Debark Luggage Tags” contain important information which will direct Debarked Passengers to their specific Ground Transportation Sources available at the Pier, and will expedite debarked passengers to their “Local, Intermediate, and/or Final Destinations”.

NOTE: Special configuration and design parameters, as well as luggage tag physical sizes, shapes, and color coding may be customized to meet each Cruise Line's individual requirements.

### DRAWINGS

The following drawings of “Combination Embark-Debark Luggage Tags” are provided:

Drawing 1, One set of 4 new luggage tags showing 3 basic pre-printed parameters, and One tag with luggage Instructions on the back

Drawing 2, One set of 4 new luggage tags showing 3 different Ship Names, 3 different Passenger Names, Addresses, etc., 3 different Cabin Nos., and one tag with Instructions on the back.

Drawing 3, One set of 4 new luggage tags showing 3 sets of passenger information which is different than those shown in Drawing 2.

1-12. (canceled)

13. The “Combination Embark-Debark Luggage Tag” provides the cruise line industry:
(a) the opportunity to standardize the current costly practice of using many different kinds of passenger luggage tags and information for “embarking” passenger luggage onto cruise ships;
(b) the opportunity to standardize the current costly practice of using many different kinds of passenger luggage tags and information for “debarking” passenger luggage off of cruise ships;
(c) 10 passenger specific “embark parameters” including each passenger's Sailing Date, Passenger Name, Address, City, State, Zip Code, Telephone No., Cabin No., Cabin Location Quadrant, and the Name of the Cruise Line;
(d) 10 passenger specific “debark parameters” including each passenger's Ship Name, Debark Date, Destination, Airline and Flight No., Flight Time, Other Transportation, Debark No., Luggage Reclaim No., and Cruise Line Address and Telephone No.; and
(e) said luggage tag's combined 20 passenger specific parameters provide the accurate, consistent, complete passenger reservation information necessary for all cruise line agents to cost-effectively process all passenger luggage “into and out” of Port Terminals and “onto and off” of Cruise Ships.

14. The luggage tag claimed in 13. (New). is comprised of:
(a) a tag 2 inches wide, 14 inches long, printed front-side and back-side on white label stock;
(b) said tags may be manufactured as single individual tags, multiple tags on cut sheets, or single tags on continuous rolls;
(c) the front-side length is divided into two equal halves, each half having different functional parts;
(d) the front-side left-half is printed with each passenger's 10 specific “embark parameters” which are obtained from each cruise line's passenger reservation system;
(e) the front-side right-half is printed with each passenger's 10 specific “debark parameters” which are obtained from each cruise line's passenger reservation system;
(f) the said combined 20 parameters provide cruise line agents readily available information required to accurately route each and all pieces of each and all passenger's luggage;
(g) the said combined 20 parameters provide cruise line agents readily available information required to accurately identify and reunite passenger's with their delayed, damaged, lost, or unclaimed luggage;
(h) the said combined 20 parameters provide cruise line agents readily available information required to accurately complete the reports required relating to passenger luggage; and
(i) the back-side printed as required by each cruise line's specific “Luggage Tag Instructions”. i

15. The luggage tag claimed in 13. (New). above further comprises:
(a) a circled “Debark No.” 1 thru 9 which determines each passenger's specific order of debarkation from the ship and into the port terminal;
(b) said “Debark No.” also determines how and where cruise line agents sort and locate passenger's luggage inside of the port terminal;
(c) said “Debark No.” is assigned by the cruise line reservation system and is directly related to each passenger's specific ground and air transportation requirements, and intermediate and final destination;
(d) a three part “Luggage Reclaim No.” is detachable from each passenger luggage tag and is required when each passenger reclaims their luggage at the end of their cruise; and
(e) said “Luggage Reclaim No.” is assigned by the cruise line reservation system and includes the said debark numbers 1 thru 9, the 4 digit passenger's cabin number, and the letters A, B, C, or D which identify each piece of that passengers luggage.
